(19) United States
(12) Patent Application Publication
(10) Pub. No.: US 2026/0171278 A1
(43) Pub. Date: Jun. 18, 2026

(54) SEQUENTIAL TARGET SYSTEM FOR PHOTONUCLEAR RADIOISOTOPE PRODUCTION

(71) Applicant: IOTRON MEDICAL, INC., Morristown, NJ (US)

(72) Inventors: David A. EHST, Reston, VA (US); Mykola AIZATSKYI, Kharkiv (UA); Vyacheslav UVAROV, Kharkiv (UA)

(21) Appl. No.: 19/129,431

(22) PCT Filed: Nov. 13, 2023
(86) PCT No.: PCT/US2023/079490

§ 371 Date: May 13, 2025

Related U.S. Application Data
(60) Provisional application No. 63/383,622, filed on Nov. 14, 2022.

(51) Int. Cl. G21G 1/12

(52) U.S. Cl. CPC G21G 1/12

(57) ABSTRACT

In some embodiments, apparatuses and methods are provided herein useful to producing radioisotopes. In some embodiments, a system for producing radioisotopes comprises a high energy photon source, wherein the high energy photon source is configured to emit photons, a first target, wherein the first target is positioned behind the photon source and configured to be irradiated by the photons, and a second target, wherein the second target is positioned behind the first target and configured to be irradiated by the photons, and wherein the second target is a different material than the first target.

### TECHNICAL FIELD

This disclosure relates generally to radioisotope production and, more specifically, systems and methods for radioisotope production.

### BACKGROUND

Production of radioisotopes is valuable for many applications, such as the medical industry. Currently, most radioisotope production systems operate by irradiating a target with a radiation source, such as a nuclear reactor or accelerator. As can be expected, such equipment, and the ultimate production of radioisotopes, is expensive and complex. With some current systems, the “source radiation” (i.e., the radiation produced by the radiation source) is typically underutilized (i.e., not used as effectively and/or efficiently as possible). For example, once the radiation passes through or passes the target, the radiation is no longer used in the production of radioisotopes. Because the systems and actual production are expensive, a need exists to develop improved systems and methods that are more cost effective and/or efficient.

### BRIEF DESCRIPTION OF THE DRAWINGS

Disclosed herein are embodiments of systems, apparatuses, and methods pertaining production of radioisotopes. This description includes drawings, wherein:

FIG. 1 is a block diagram of a system 100 for producing radioisotopes 118 with a sequential target, according to some embodiments;

FIG. 2 is a block diagram of a system 200 for producing radioisotopes 218 with a sequential target, according to some embodiments;

FIGS. 3A-3C depict example arrangements for a sequential target, according to some embodiments;

FIG. 4 depicts an example of types of materials and radioisotopes produced with a sequential target 400, according to some embodiments; and

FIG. 5 is a flow chart depicting example operations for producing radioisotopes, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

Generally speaking, pursuant to various embodiments, systems, apparatuses, and methods are provided herein useful to producing radioisotopes. In some embodiments, a system for producing radioisotopes comprises a high energy photon source, wherein the high energy photon source is configured to emit photons, a first target, wherein the first target is positioned behind the photon source and configured to be irradiated by the photons, and a second target, wherein the second target is positioned behind the first target and configured to be irradiated by the photons, and wherein the second target is a different material than the first target.

As discussed previously, radioisotopes are used in many different fields. One such field is medicine. For example, radioisotopes can be used in medical imaging and treatment. While radioisotopes are used in many different applications, the equipment needed to produce radioisotopes, and the actual production of radioisotopes, is expensive and complex.

Typical high energy photon systems for producing radioisotopes include a single target that is irradiated. Irradiating the target converts a very small portion of the target nuclei into a radioactive form that can be harvested. In passing through the target, the radiation is degraded in energy and intensity. Once the radiation has passed the target, it is no longer used in radioisotope production. Though the radiation that has passed the target is not used in radioisotope production, it could still be useful for irradiating additional targets, whether the same as previous targets or targets having different characteristics (e.g., to produce different radioisotopes).

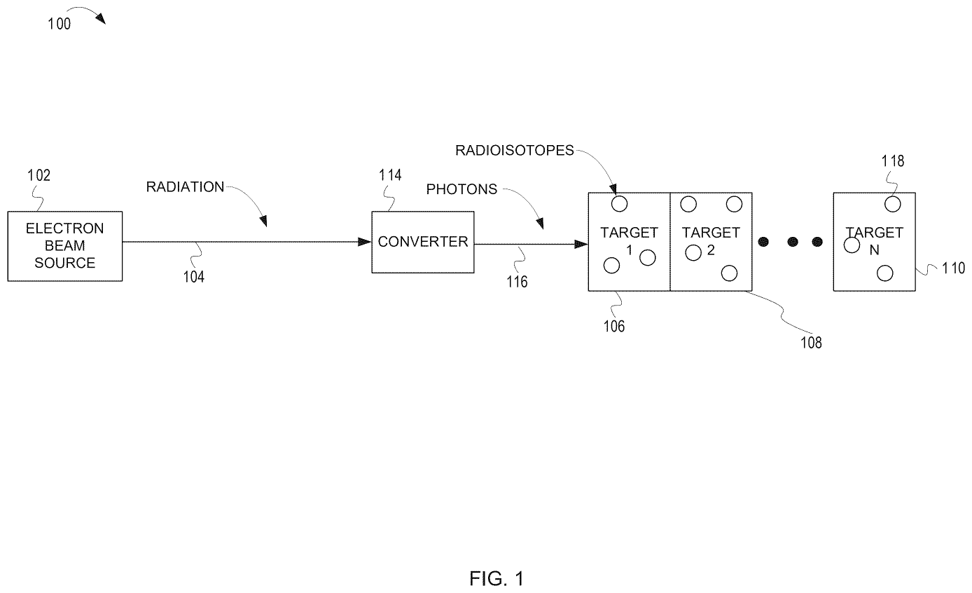

Described herein are systems, methods, and apparatuses that seek to at least minimize, if not eliminate, some of the drawbacks of current systems. In one embodiment, a system for producing radioisotopes includes multiple targets arranged sequentially (i.e., in a target stack). For example, the targets can be arranged one behind the other. In such a system, the radiation can be used to irradiate not only the first target, but also the subsequent targets, achieving a greater utilization of the radiation source energy. Put simply, the sequential arrangement of the targets can better utilize the produced radiation than a system that includes only a single target. Because of this, a greater number of radioisotopes can be produced than with a single target and the overall efficiency of the system is increased. The discussion of FIG. 1 provides an overview of such a system.

FIG. 1 is a block diagram of a system 100 for producing radioisotopes 118 with a sequential target, according to some embodiments. The system 100 includes an electron beam source 102, a converter 114, and targets. The electron beam source 102 is configured to emit an electron beam 104, and can be of any suitable type. For example, the electron beam source 102 can be a linear accelerator, a microtron, a Rhodotron, etc. The converter 114 is configured to receive the radiation 104 and emit photons 116. The converter can be of any type suitable for emitting photons. For example, the converter 114 can be a converter plate or a series of plates (e.g., Bremsstrahlung converter), a gas, liquid, solid, etc. In one embodiment, the photons 116 emitted by the converter 114 are high energy photons (i.e., photons with energies of 10 MeV or greater). Accordingly, the radiation source 102 and the converter 114 can be selected to achieve such photon production.

Located behind (i.e., downstream with respect to the emission of the radiation 104 and/or photons 116) the converter 114 are the targets (i.e., a target stack). As depicted in FIG. 1, there are N total targets in the target stack: 1) a first target 106; 2) a second target 108; . . . N) an Nth target 110. As indicated by the Nth target 110, the system can be adapted for use with any suitable number of targets.

Further, as depicted in FIG. 1, each subsequent target is located behind (i.e., downstream with respect to the flow of the radiation 104 and/or photons 116) its previous target. For example, as depicted in FIG. 1, the second target 108 is located behind the first target 106 and in front of the Nth target 110. When each target in the target stack is irradiated by the photons, a photonuclear reaction occurs in at least a portion of the nuclei of the target. The photonuclear reaction causes the removal of protons, neutrons, and/or other particles from the nuclei, resulting in the radioisotopes 118 being produced within the targets. In embodiments where the targets are of different types (i.e., different materials), each of the targets may produce different radioisotopes 118.

Though not depicted in FIG. 1, in some embodiments, the system 100 also includes a collection device. The collection device is configured to remove the target stack and/or individual targets or target materials from the system. In such embodiments, one or more of the targets can be removed before the radioisotopes 118 are harvested from the target(s). For example, in some embodiments, one or more of the targets can be removed independently from the system 100. That is, in such embodiments, one or more of the targets can be removed (i.e., collected) from the system 100 without removing or otherwise disturbing others of the targets. This can allow, for example, removal of one or more targets without interrupting radioisotope production in others of the targets. The collection device can be of any suitable type and can include mechanical devices (e.g., levers, arms, clamps, etc.) to remove solid targets as well as mechanical devices (e.g., valves, tubes, etc.) to remove fluid (i.e., gas or liquid) targets from the target stack. Put simply, entire targets and/or target material can be collected from the system via the collection device. Further, in some embodiments, the system 100 can be designed such that one or more of the targets are individually removable from the system 100.

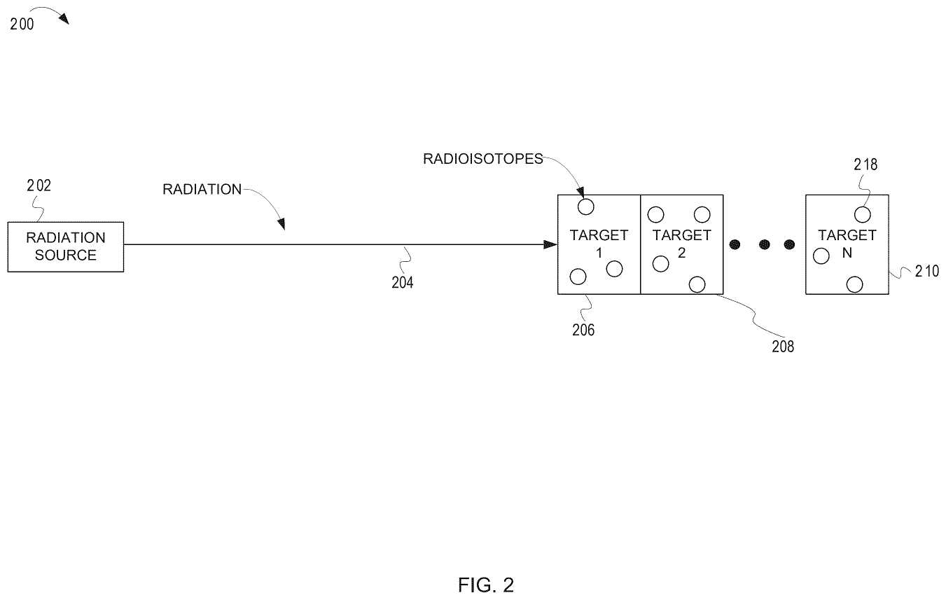

While the discussion of FIG. 1 provides an overview of a system for producing radioisotopes including a radiation source and a converter, the discussion of FIG. 2 provides an overview of a system for producing radioisotopes including a photon source.

FIG. 2 is a block diagram of a system 200 for producing radioisotopes with a sequential target, according to some embodiments. The system 200 includes a radiation source 202 and targets. The radiation source 202 is configured to emit radiation 204. In some embodiments, the radiation source 202 can directly emit photons (e.g., high energy photons). In such embodiments, the radiation source 202 can be, for example, a laser backscatter system (e.g., a Compton laser backscatter system). Alternatively, the radiation source 202 can emit an electron beam. In such embodiments, the radiation source 202 can be, for example, a linear accelerator, microtron, Rhodotron, etc. In such embodiments, one or more of the targets in the target stack can act as a converter, emitting photons as a result of the incident electron beam.

Located behind (i.e., downstream with respect to the emission of the photons 204) the radiation source 202 are the targets (i.e., a target stack). As depicted in FIG. 2, there are N total targets: 1) a first target 206; 2) a second target 208; . . . N) an Nth target 212. As indicated by the Nth target 210, the system can be adapted for use with any suitable number of targets.

Further, as depicted in FIG. 2, each subsequent target is located behind (i.e., downstream with respect to the flow of the photons 204) its previous target. For example, as depicted in FIG. 2, the second target 208 is located behind the first target 206 and in front of the Nth target 210. When each target in the target stack is irradiated by the photons, a photonuclear reaction occurs in at least a portion of the nuclei of the target. The photonuclear reaction causes the removal of protons, neutrons, and/or other particles from the nuclei, resulting in the radioisotopes 218 being produced within the targets. In embodiments where the targets are of different types (i.e., different materials), each of the targets may produce different radioisotopes 218. Unlike the system depicted in FIG. 1, the system 200 does not include a converter. Rather, the first target 206 (and possibly one or more of the subsequent targets) can act as the converter by producing photons when irradiated. Accordingly, the first target 206 can produce both photons (e.g., high energy photons) and radioisotopes 218. In such embodiments, it may be beneficial to use as a target material for the first target 206 a material having a significant component with a high atomic number (e.g., a heavy metal).

Though not depicted in FIG. 2, in some embodiments, the system 200 also includes a collection device. The collection device is configured to remove the target stack and/or individual targets from the system. In such embodiments, one or more of the targets can be removed before the radioisotopes 218 are harvested from the target(s). For example, in some embodiments, one or more of the targets can be removed independently from the system 100. That is, in such embodiments, one or more of the targets can be removed (i.e., collected) from the system 100 without removing or otherwise disturbing others of the targets. This can allow, for example, removal of one or more targets without interrupting radioisotope production in others of the targets. The collection device can be of any suitable type and can include mechanical devices (e.g., levers, arms, clamps, etc.) to remove solid targets as well as mechanical devices (e.g., valves, tubes, etc.) to remove fluid (i.e., gas or liquid) targets from the target stack. Put simply, entire targets and/or target material can be collected from the system via the collection device. Further, in some embodiments, the system 200 can be designed such that one or more of the targets are individually removable from the system 200.

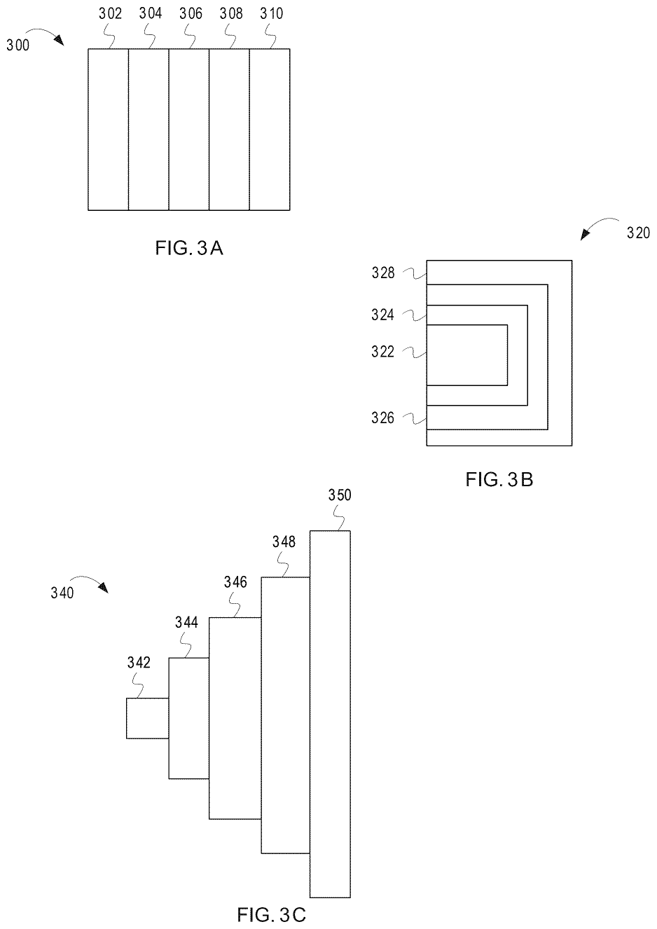

While the discussion of FIGS. 1 and 2 provides an overview of systems for producing radioisotopes, the discussion of FIGS. 3A-3C provides additional detail about target arrangement.

FIGS. 3A-3C depict example arrangements for a sequential target, according to some embodiments. FIG. 3A depicts a stacked configuration of targets. As depicted in FIG. 3A, the target stack 300 includes five total targets: 1) a first target 302; 2) a second target 304; 3) a third target 306; 4) a fourth target 308; and 5) a fifth target 310. While the example depicted in FIG. 3A includes five targets, embodiments are not so limited. For example, the target stack 300 can include greater, or fewer, than five targets. Each target (other than the first target 302 and last target 310) is located between its previous and subsequent targets. For example, the third target 306 is located between the second target 304 and the fourth target 308. As noted previously, directionally, the terms “behind” and “before” (and similar terms) are used with reference to the flow of photons and/or radiation in the system.

FIG. 3B depicts a nested configuration of targets. As depicted in FIG. 3B, the target stack 320 includes four total targets: 1) a first target 322; 2) a second target 324; 3) a third target 326; and 4) a fourth target 328. While the example depicted in FIG. 3B includes four targets, embodiments are not so limited. For example, the target stack 320 can include greater, or fewer, than four targets. Each target (other than the first target 322 and the last target 328) is located between its previous and subsequent targets. For example, the second target 324 is located between the first target 322 and the third target 326. Unlike the stacked configuration shown in FIG. 3A, the previous target does not completely cover the next target in the target stack 320. That is, a portion of each subsequent target is not completely behind the previous target. For example, referring again to the second target 324, a portion of the second target 324 is not behind/covered by the first target 322 and therefore may be exposed to photons that have not yet contacted and/or penetrated any of the other targets in the target stack 320. Further, it should be noted, that the target stack 320 (or any other target stacks described herein) can take any suitable shape. For example, the target stack 320 can be rectangular, spherical, round, cylindrical, etc. As one example, FIG. 3B can depict a cross section of a cylindrical target stack.

FIG. 3C depicts a pyramid configuration of targets. As depicted in FIG. 3C, the target stack 340 includes five total targets: 1) a first target 342; 2) second target 344; 3) a third target 346; 4) a fourth target 348; and 5) a fifth target 350. While the example depicted in FIG. 3C includes five targets, embodiments are not so limited. For example, the target stack 340 can include greater, or fewer, than five targets. Each target (other than the first target 342 and the last target 350 is located between its previous and subsequent targets. For example, the second target 344 is located between the first target 342 and the third target 346. Unlike the stacked configuration shown in FIG. 3A, the previous target does not completely cover the next target in the target stack 340. That is, a portion of each subsequent target is not completely behind the previous target. For example, referring again to the second target 344, a portion of the second target 344 is not behind/covered by the first target 342 and therefore may be exposed to photons that have not yet contacted and/or penetrated any of the other targets in the target stack 340.

Though not depicted in the examples provided in FIGS. 3A-3C, in some embodiments, the target stack can include one or more cooling elements. The one or more cooling elements can be positioned around (e.g., above, below, between, etc.) one or more of the targets in the target stack to aid in dissipating heat created by the irradiation of the target stack. The cooling element can include liquid and/or gas channels to allow cooling fluid to contact (directly and/or indirectly) one or more of the targets in the target stack. The cooling elements can be part of a larger cooling system, such as a bath-cooled system, an industrial blower system, a high-pressure gas system, etc. For example, the cooling elements can include passageways for fluid to flow between the targets. Additionally, though each of the targets in FIGS. 3A-3C is depicted as touching its neighboring targets, such is not required (e.g., gaps may exist between the targets, the targets may be contained within housings for irradiation, etc.). Further, in some embodiments, one or more of the targets may be individually removable from the target stack.

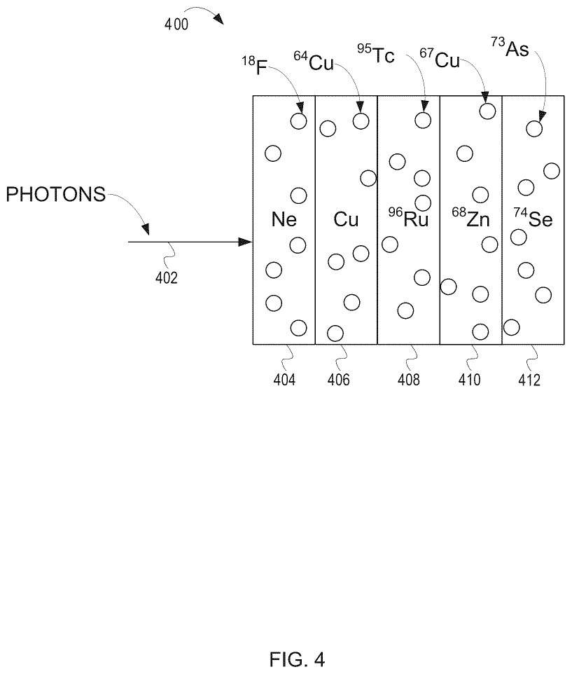

While the discussion of FIGS. 1-3 provides an overview of systems for producing radioisotopes and examples of sequential target arrangements, the discussion of FIG. 4 provides additional detail regarding a specific series of targets.

FIG. 4 depicts an example of types of materials and radioisotopes produced with a target stack 400, according to some embodiments. As depicted in FIG. 4, the target stack 400 includes five targets: 1) a first target 404; 2) a second target 406; 3) a third target 408; 4) a fourth target 410; and 5) a fifth target 412. The targets are arranged in a stacked configuration, though such is not required and the stacked configuration is used as an example only. As depicted in FIG. 4, the first target 404 is Neon (e.g., naturally occurring Neon), the second target 406 is Copper (e.g., naturally occurring copper), the third target 408 is Ruthenium-96 (e.g., enriched Ruthenium-96), the fourth target 410 is Zinc-68 (e.g., enriched Zinc-68), and the fifth target 412 is Selenium-74 (e.g., enriched Selenium-74. Though neon, copper, ruthenium, zinc, and selenium are shown as targets in the example depicted in FIG. 4, such is not required. That is, any suitable number, and types, of targets can be used to produce the desired radioisotopes.

The target stack 400 is irradiated with photons 402 (e.g., high energy photons). Each target in the target stack produces a different radioisotope upon irradiation. For example, and as depicted in FIG. 4, the first target 404 (i.e., Neon) produces Flourine-18, the second target 406 (i.e., Copper) produces Copper-64, the third target 408 (i.e., Ruthenium-96) produces Technetium-95, the fourth target (i.e., Zinc-68) produces Copper-67, and the fifth target 412 (i.e., Selenium-74) produces Arsenic-73 when irradiated.

The targets of the target stack 400 can be arranged in any suitable order. As but one example, the targets can be arranged based on the half-life of the radioisotope produced by the target material. Such an arrangement can optimize the utilization of the radiation source, especially when the time interval between harvesting cycles is optimized based on the types of targets. In this example, the targets can be arranged with the target producing the radioisotope with the shortest half-life first, followed by the target producing the radioisotope with the second longest half-life next, and so on with the last target producing the radioisotope with the longest half-life. Additionally, though the targets of the target stack 400 depicted in FIG. 4 are shown as having similar thicknesses, shape, etc., such is not required. For example, different ones of the targets may have different surface areas, densities, shapes, thickness, etc.

Though the targets in FIG. 4 are arranged in order of half-life of the radioisotope produced, any suitable arrangement can be used. As another, example, the targets can be arranged in order of photon absorption. For example, the targets can be arranged such that the first target has the lowest photon absorption, the second target has the second lowest photon absorption, etc. As a third example, the targets can be arranged based on thickness and/or surface area. For example, thinner targets with larger surface areas can be located earlier in the target stack. As a fourth example, the targets can be arranged based on type. For example, gaseous targets can be placed before liquid targets, and liquid targets can be placed before solid targets. Though several examples of target arrangement are provided herein, it should be recognized that a large number of possible target arrangements exist based on the desired outcome and all such arrangements are contemplated herein.

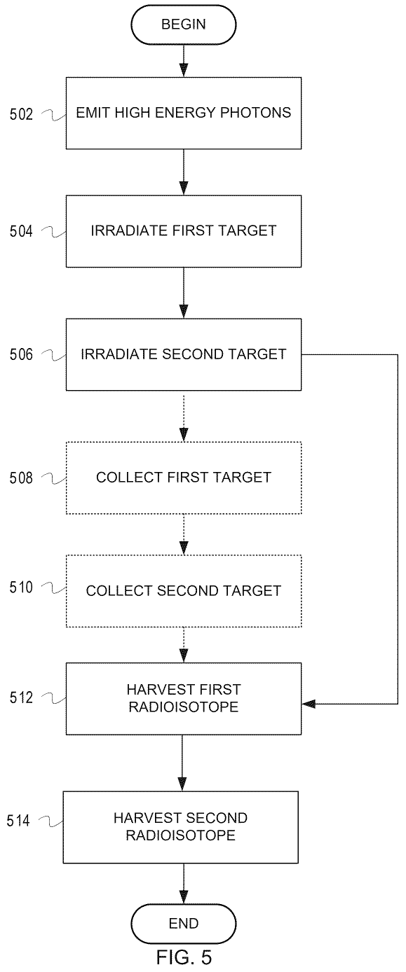

While the discussion of FIGS. 1-4 provides additional detail regarding a system for producing radioisotopes with a sequential target, the discussion of FIG. 5 describes example operations of such systems. It should be noted that although the operations depicted in FIG. 5 are presented as occurring in series, such is not required. For example, in practice, one or more of the operations depicted in FIG. 5 may be performed simultaneously. Additionally, in practice, one or more of the operations depicted in FIG. 5 can occur in an order other than that presented in FIG. 5.

FIG. 5 is a flow chart depicting example operations for producing radioisotopes, according to some embodiments. The flow begins at block 502.

At block 502, high energy photons are emitted. For example, the high energy photons can be emitted by a converter and/or one or more of the targets. For example, as described with respect to FIG. 1, an electron beam source can emit radiation that irradiates a converter. The irradiation of the converter produces photons that are emitted by the converter. In such embodiments, the photons emitted by the converter can be high energy photons and the converter (possibly in concert with the electron beam source) can be a source of high energy photons. As another example, and as described with respect to FIG. 2, a radiation source can emit photon and/or electron radiation that irradiates one or more targets in a target stack. In such embodiments, the irradiation of the one or more targets causes a photonuclear reaction to occur within the nuclei of atoms in the one or more targets. Regardless of the source of the high energy photons, high energy photons are emitted into the target stack. The flow continues at block 504.

At block 504, a first target is irradiated. For example, the first target can be irradiated by the high energy photons. As described herein, a group of targets is arranged sequentially to form a target stack. The target stack includes two or more targets. When the first target is irradiated by the high energy photons, a photonuclear reaction occurs in the first target. This photonuclear reaction causes a nuclear reaction inside the nuclei in the first target, producing a first radioisotope. It should be noted that the photonuclear reaction could result in a number of different radioisotopes being produced within the first target. However, for the ease of discussion, the photonuclear reaction will generally be described as producing a single type of radioisotope. The flow continues at block 506.

At block 506, a second target is irradiated. For example, the second target can be irradiated by the high energy photons. As previously discussed, the targets are arranged in a target stack including two or more targets. When the second target is irradiated by the high energy photons, a photonuclear reaction occurs in the second target. This photonuclear reaction causes a nuclear reaction inside the nuclei in the second target, producing a second radioisotope. It should be noted that the photonuclear reaction could result in a number of different radioisotopes being produced within the second target. However, for the ease of discussion, the photonuclear reaction will generally be described as producing a single type of radioisotope. The flow optionally continues at block 508. If optional blocks 508 and 510 are skipped, the flow continued at block 512.

At block 508, the first target is collected. For example, the first target can be collected via a collection device. During the collection process, the first target and/or material from the first target are removed with the collection device. The collection device can be of any suitable type and can include mechanical devices (e.g., levers, arms, clamps, etc.) to remove solid targets as well as mechanical devices (e.g., valves, tubes, etc.) to remove fluid (i.e., gas or liquid) targets from the target stack. In embodiments that include collection of the first target, the first target can be collected before a first radioisotope is harvested from the first target. The flow continues at block 510.

At block 510, the second target is collected. For example, the second target can be collected via a collection device. During the collection process, the second target and/or material from the second target are removed with the collection device. The collection device can be of any suitable type and can include mechanical devices (e.g., levers, arms, clamps, etc.) to remove solid targets as well as mechanical devices (e.g., valves, tubes, etc.) to remove fluid (i.e., gas or liquid) targets from the target stack. In embodiments that include collection of the second target, the second target can be collected before a second radioisotope is harvested from the second target. The flow continues at block 510. At block 510, the first radioisotope is harvested. For example, the first radioisotope can be harvested from the first target after the first target is irradiated with the high energy photons. As used herein, the term “harvest” is used to refer to any process intended to produce a useful radioisotope product from the target (e.g., via separation, purification, manufacture (e.g., into a form and/or shape), etc.). The first radioisotope can be harvested from the first target by any suitable means. For example, dependent upon the type of the first radioisotope and the type of the first target, the first radioisotope can be harvested from the first target by a chemical (e.g., via an ion exchange) and/or physical (e.g., via a sublimation) process. Put simply, any suitable method for processing radioisotopes from a target can be used to harvest the first radioisotopes from the first target. Further, in some embodiments, before the first radioisotope is harvested, the first target is collected from the system, as noted in optional block 506. For example, the first target can be collected via physical removal and/or isolation from the target stack before the first radioisotope is harvested from the first target. The flow continues at block 512.

At block 512, the first radioisotope is harvested. For example, the first radioisotope can be harvested from the first target after the first target is irradiated with the high energy photons. As used herein, the term “harvest” is used to refer to any process intended to produce a useful radioisotope product from the target (e.g., via separation, purification, manufacture (e.g., into a form and/or shape), etc.). The first radioisotope can be harvested from the first target by any suitable means. For example, dependent upon the type of the first radioisotope and the type of the first target, the first radioisotope can be harvested from the first target by a chemical (e.g., via an ion exchange) and/or physical (e.g., via a sublimation) process. Put simply, any suitable method for processing radioisotopes from a target can be used to harvest the first radioisotopes from the first target. Further, in some embodiments, before the first radioisotope is harvested, the first target is collected from the system, as noted in optional block 508. For example, the first target can be collected via physical removal and/or isolation from the target stack before the first radioisotope is harvested from the first target. The flow continues at block 514.

At block 514, the second radioisotope is harvested. For example, the second radioisotope can be harvested from the second target after the second target is irradiated with the high energy photons. As used herein, the term “harvest” is used to refer to any process intended to produce a useful radioisotope product from the target (e.g., via separation, purification, manufacture (e.g., into a form and/or shape), etc.). The second radioisotope can be harvested from the second target by any suitable means. For example, dependent upon the type of the second radioisotope and the type of the second target, the second radioisotope can be harvested from the second target by a chemical (e.g., via an ion exchange) and/or physical (e.g., via a sublimation) process. Put simply, any suitable method for removing radioisotopes from a target can be used to harvest the second radioisotopes from the second target. Further, in some embodiments, before the second radioisotope is harvested, the second target is collected from the system, as noted in optional block 508. For example, the second target can be collected via physical removal and/or isolation from the target stack before the second radioisotope is harvested from the first target.

In some embodiments, a system for producing radioisotopes comprises a high energy photon source, wherein the high energy photon source is configured to emit photons, a first target, wherein the first target is positioned behind the photon source and configured to be irradiated by the photons, and a second target, wherein the second target is positioned behind the first target and configured to be irradiated by the photons, and wherein the second target is a different material than the first target.

In some embodiments, an apparatus and a corresponding method performed by the apparatus comprises emitting, by a high energy photon source, photons, irradiating, via the photons, a first target, wherein the first target is positioned behind the photon source, irradiating, via the photons, a second target, wherein the second target is located behind the first target, and wherein the second target is a different material than the first target, collecting a first radioisotope, wherein the first radioisotope is produced within the first target, and collecting a second radioisotope, wherein the second radioisotope is produced within the second target.

In some embodiments, a system for producing radioisotopes within multiple targets comprises a high energy photon source, wherein the high energy photon source is configured to emit photons, and a plurality of targets, wherein the targets are arranged in series behind the high energy photon source, wherein each of the plurality of targets is configured to be irradiated by the photons, and wherein at least one of the plurality of targets is a different material than others of the plurality of targets.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system for producing radioisotopes, the system comprising:
a high energy photon source, wherein the high energy photon source is configured to emit photons;
a first target, wherein the first target is positioned behind the photon source and configured to be irradiated by the photons;
a second target, wherein the second target is positioned behind the first target and configured to be irradiated by the photons, and wherein the second target is a different material than the first target.

2. The system of claim 1, further comprising:
a third target, wherein the third target is positioned behind the first target and configured to be irradiated by the photons, and wherein the third target is a different material than one or more of the first target and the second target.

3. The system of claim 1, wherein the first target has a first thickness and the second target has a second thickness, and wherein the first thickness is different than the second thickness.

4. The system of claim 1, wherein the first target and second target are arranged in one of a nested configuration, a stack configuration, and a pyramid configuration.

5. The system of claim 1, further comprising:
a cooling element, wherein the cooling element is configured to dissipate heat from one or both of the first target and the second target.

6. The system of claim 1, wherein the photon source is a converter plate, and wherein the converter plate is configured to emit the photons in response to an electron beam.

7. The system of claim 1, wherein the first target and the second target are independently removable.

8. The system of claim 1, wherein a first radioisotope is produced within the first target and a second radioisotope is produced within the second target, wherein the first radioisotope has a first half-life and the second radioisotope has a second half-life, and wherein the second half-life is longer than the first half-life.

9. A method for producing radioisotopes, the method comprising:
emitting, by a high energy photon source, photons;
irradiating, via the photons, a first target, wherein the first target is positioned behind the high energy photon source;
irradiating, via the photons, a second target, wherein the second target is located behind the first target, and wherein the second target is a different material than the first target;
harvesting a first radioisotope, wherein the first radioisotope is produced within the first target; and
harvesting a second radioisotope, wherein the second radioisotope is produced within the second target.

10. The method of claim 9, further comprising:
irradiating, via the photons, a third target, wherein the third target is positioned behind the second target, and wherein the third target is a different material than one or more of the first target and the second target.

11. The method of claim 9, wherein the first target has a first thickness and the second target has a second thickness, and wherein the first thickness is different than the second thickness.

12. The method of claim 9, wherein the first target and the second target are arranged in one of a nested configuration, a stack configuration, and a pyramid configuration.

13. The method of claim 9, wherein a cooling element is configured to dissipate heat from one or both of the first target and the second target.

14. The method of claim 9, wherein the photon source is a converter plate, and wherein the converter plate is configured to emit the photons in response to an electron beam.

15. The method of claim 9, wherein the first target and the second target are independently removable.

16. The method of claim 9, wherein a first radioisotope produced within the first target and a second radioisotope is produced within the second target, wherein the first radioisotope has a first half-life and the second radio-isotope has a second half-life, and wherein the second half-life is longer than the first half-life.

17. A system for producing radioisotopes within multiple targets, the system comprising:
a high energy photon source, wherein the high energy photon source is configured to emit photons; and
a plurality of targets, wherein the targets are arranged in a target stack behind the high energy photon source, wherein each of the plurality of targets is configured to be irradiated by the photons, and wherein at least one of the plurality of targets is a different material than others of the plurality of targets.

18. The system of claim 17, wherein the plurality of targets are arranged in one of a nested configuration, a stack configuration, and a pyramid configuration.

19. The system of claim 1, further comprising:
a plurality of cooling elements, wherein one of the plurality of cooling elements is disposed between adjacent ones of the plurality of targets.

20. The system of claim 17, wherein each target of the plurality of targets is individually removable.
